(19) United States
(12) Patent Application Publication
(10) Pub. No.: US 2024/0339096 A1
(43) Pub. Date: Oct. 10, 2024

(54) MUSICAL SOUND CONTROL APPARATUS, MUSICAL SOUND CONTROL METHOD AND NON-TRANSITORY COMPUTER-READABLE STORAGE MEDIUM

(71) Applicant: CASIO COMPUTER CO., LTD., Tokyo (JP)

(72) Inventors: Reo FUJII, Tokyo (JP); Ryohei KOBAYASH, Tokyo (JP)

(73) Assignee: CASIO COMPUTER CO., LTD., Tokyo (JP)

(21) Appl. No.: 18/750,131

(22) Filed: Jun. 21, 2024

Related U.S. Application Data
(63) Continuation of application No. PCT/JP2022/040699, filed on Oct. 31, 2022.

(30) Foreign Application Priority Data
Dec. 22, 2021 (JP) 2021-207688

(51) Int. Cl. G10H 3/18

(52) U.S. Cl. CPC G10H 3/186; G10H 2220/201; G10H 2220/391; G10H 2220/395

(57) ABSTRACT

A musical sound control apparatus includes a first detector to detect a tension generated between a musical instrument and a holder, an output device to output a signal corresponding to a detection value detected by the first detector, a second detector to detect a specific movement of at least a part of the apparatus, and a processor that executes a determination process to determine whether the specific movement meets a predetermined condition when the specific movement is detected, and a switching process to switch between a first mode and a second mode if it is determined that the specific movement meets the predetermined condition, and the first mode changes the signal according to a change in the detection value, and the second mode holds the signal when the specific movement was detected, without changing the signal even if the detection value changes.

### CROSS-REFERENCE TO RELATED APPLICATION

This application is based upon and claims the benefit of priority under 35 USC 119 of Japanese Patent Application No. 2021-207688 filed on Dec. 22, 2021, the entire disclosure of which, including the specification, claims, drawings and abstract, is incorporated herein by reference in its entirety.

### BACKGROUND

### Technical Field

The present disclosure relates to a musical sound control apparatus, a musical sound control method, and a non-transitory computer-readable storage medium.

### Description of the Related Art

There have conventionally been proposed technologies in which a sensor or the like is incorporated between a musical instrument and a strap with which a player holds the musical instrument, a force generated as a result of the player pulling the strap is detected by the sensor or the like, and a signal configured to control a musical sound is output according to a detection value detected by the sensor or the like. For example, Japanese Utility Model Publication No. 59-60692 disclose a portable electronic musical instrument including a pressure sensor or an extension detection sensor which is incorporated in a strap. With this portable electronic musical instrument, a signal configured to control a musical sound according to a detection value of the sensor is output by moving the musical instrument to apply a pressure to or generate an extension in the strap to control the pitch bending, modulation amount, volume, and the like of the portable electronic musical instrument. As a result, the musical sound can be controlled without performing a switching operation while holding the musical instrument with both hands of the player.

### SUMMARY

According to an aspect of the present disclosure, there is provided a musical sound control apparatus including a first detector configured to detect a tension generated between a musical instrument and a musical instrument holder, an output device configured to output a signal corresponding to a detection value detected by the first detector, a second detector configured to detect a specific movement of at least a part of the musical sound control apparatus and a processor, wherein the processor executes a determination process configured to determine whether the specific movement meets a predetermined condition when the specific movement is detected by the second detector, and a switching process configured to switch between a first mode and a second mode if it is determined in the determination process that the specific movement meets the predetermined condition, wherein the first mode changes the signal output by the output device according to a change in the detection value detected by the first detector, and the second mode holds the signal that was output by the output device when the specific movement was detected, without changing the signal output by the output device even if the detection value changes.

According to another aspect of the present disclosure, there is provided a musical sound control method for a musical sound control apparatus comprising a first detector configured to detect a tension generated between a musical instrument and a musical instrument holder, an output device configured to output a signal corresponding to a detection value detected by the first detector, a second detector configured to detect a specific movement of at least a part of the musical sound control apparatus, and a processor, wherein the processor executes a determination process configured to determine whether the specific movement meets a predetermined condition when the specific movement is detected by the second detector and a switching process configured to switch between a first mode and a second mode if it is determined in the determination process that the specific movement meets the predetermined condition, wherein the first mode changes the signal output by the output device according to a change in the detection value detected by the first detector, and the second mode holds the signal that was output by output device when the specific movement was detected, without changing the signal output by the output device even if the detection value changes.

According to a further aspect of the present disclosure, there is provided a non-transitory computer-readable storage medium storing a program, wherein the program causes a computer of a musical sound control apparatus which comprises a first detector configured to detect a tension generated between a musical instrument and a musical instrument holder, an output device configured to output a signal corresponding to a detection value detected by the first detector, and a second detector configured to detect a specific movement of at least a part of the musical sound control apparatus, to execute determining whether the specific movement meets a predetermined condition when the specific movement is detected by the second detector and switching between a first mode and a second mode if it is determined in the determination process that the specific movement meets the predetermined condition, wherein the first mode changes the signal output by the output device according to a change in the detection value detected by the first detector, and the second mode holds the signal that was output by output device when the specific movement was detected, without changing the signal output by the output device even if the detection value changes.

### BRIEF DESCRIPTION OF THE DRAWINGS

FIG. 1 is a block diagram of a playing system in which a musical sound control apparatus according to a first embodiment of the present disclosure is used;

FIG. 2 is an enlarged perspective view of the musical sound control apparatus according to the first embodiment;

FIG. 3 is a block diagram showing an electrical configuration of the musical sound control apparatus according to the first embodiment;

FIG. 4 is a flowchart illustrating a hold process executed by a control unit in the first embodiment;

FIG. 5 is an example of a waveform illustrating a change in an output value which is a detection value of a force sensor in the first embodiment;

FIG. 6 is an enlarged perspective view of a musical sound control apparatus according to a second embodiment of the present disclosure;

FIG. 7 is a block diagram showing an electrical configuration of the musical sound control apparatus according to the second embodiment; and

FIG. 8 is a flowchart illustrating a hold process executed by a control unit in the second embodiment.

### DESCRIPTION OF THE EMBODIMENTS

### First Embodiment

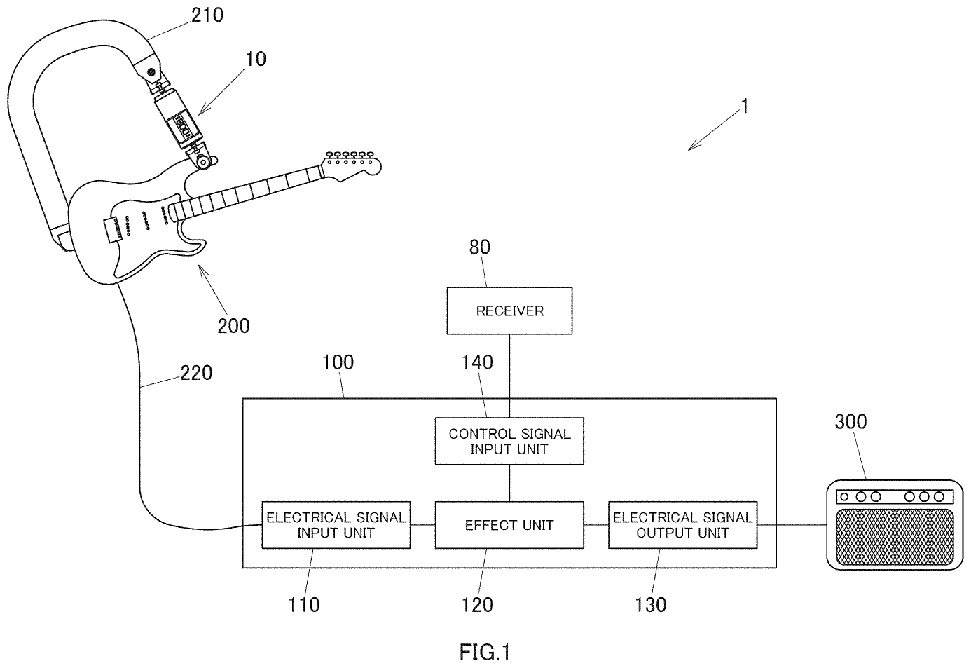

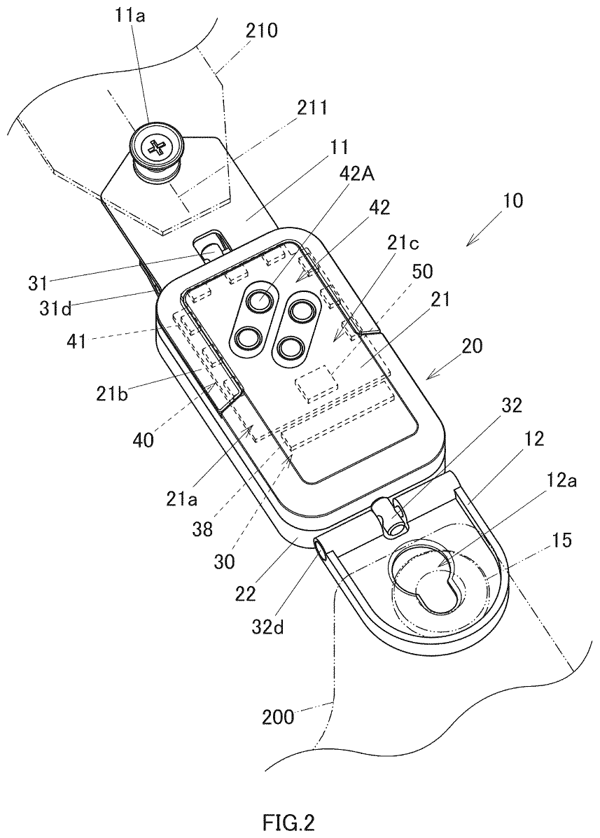

Hereinafter, referring to FIGS. 1 to 4, a first embodiment of the present disclosure will be described. In a playing system 1 shown in FIG. 1, a musical sound control apparatus 10 according to the first embodiment is provided in such a manner as to connect an electric guitar (a musical instrument) 200 and a guitar strap (a musical instrument holder) 210 which is slung over one shoulder of a player (a user) for the player to hold the electric guitar 200. In the electric guitar 200, the musical sound control apparatus 10 is connected to a strap pin 15 (refer to FIG. 2) provided at one end (a head end) of a body, and the guitar strap 210 is connected to a strap pin (not shown) provided at the other end of the body. While the electric guitar 200 is being played, the electric guitar 200 is connected to a known sound processor (an effect device) 100 via a shielded cable 220 or the like.

The sound processor 100 is a multi-effector and includes an electrical signal input unit 110, an effect unit 120, an electrical signal output unit (output device) 130 and a control signal input unit 140. The electrical signal input unit 110 receives an electrical signal output from the electric guitar 200. The electrical signal output unit 130 is connected to a known guitar amplifier 300 and outputs an electrical signal to the guitar amplifier 300. The effect unit 120 imparts various effects such as modulation and the like to an electrical signal output from the guitar amplifier 300 and changes a parameter of an effect in a manner corresponding to or according to a control signal from the musical sound control apparatus 10, which will be described later.

The control signal input unit 140 is an input unit where an input is executed by, for example, an expression pedal, and a receiver 80 is connected to the control signal input unit 140. The receiver 80 operates in the same way as a standard jack that a well-known expression pedal has, outputting the detected value as a voltage value to the sound processor 100 side, and is connected to the control signal input unit 140.

The musical sound control apparatus 10 and the receiver 80 are made to communicate with each other by way of a radio communication means such as Bluetooth Low Energy (BLE) (a registered trademark) or the like. However, the radio communication means is not limited to BLE, and hence, communications by WiFi, FM transmitter, and infrared rays may be adopted. The receiver 80 receives a control signal output from the musical sound control apparatus 10 using the radio communication means described above and then inputs the control signal so received into the control signal input unit 140 of the sound processor 100 as an operation value of the expression pedal.

Next, the configuration of the musical sound control apparatus 10 will be described. As shown in FIG. 2, the musical sound control apparatus 10 has a vertically long rectangular parallelepiped box shape. In the following description, with the musical sound control apparatus 10 attached between the electric guitar 200 and the guitar strap 210, and the guitar strap 210 slung over the shoulder of the player, an end or side of the musical sound control apparatus 10 which faces the guitar strap 210 (a shoulder end or side, a left upper end or side in FIG. 2) is referred to as an upper end or side, an opposite end or side (a guitar side, a right lower end or side in FIG. 2) is referred to as a lower end or side, a head end or side of the electric guitar 200 (a heft hand side of the player, a right upper end or side in FIG. 2) is referred to as a left side, an opposite end or side (a right hand side of the player, a left lower end or side in FIG. 2) is referred to as a right end or side, a front side of the electric guitar 200 (a nearer side in FIG. 2) is referred to as a front side, and an opposite side is referred to as a back side.

The musical sound control apparatus 10 includes a box-shaped case 20, which is an apparatus main body, a connection button component 11 connected to an upper end or side of the case 20, and a connection ring component 12 connected to a lower end or side of the case 20. The connection button component 11 is a flat plate-like component which extends short into a substantially flat plate-like shape and is connected to one end of a first shaft 31 which is exposed from the upper side of the case 20 via a first connection shaft 31d. The connection button component 11 is connected in such a manner as to rotate around a shaft axis of the first shaft 31 and to rotate around an axis of the first connection shaft 31d. A connection button 11a is provide on a front side of an upper end portion of the connection button component 11, and this connection button 11a is fastened in a circular opening (not shown) in a slit 211 provided in one end of the guitar strap 210, whereby the connection button component 11 connects the musical sound control apparatus 10 and the guitar strap 210 together.

The connection ring component 12 is a flat plate-like component which extends short into a substantially flat plate-like shape and is connected to one end of a second shaft 32 which is exposed from the lower side of the case 20 via a second connection shaft 32d. The connection ring component 12 is connected in such a manner as to rotate around a shaft axis of the second shaft 32 and to rotate around an axis of the second connection shaft 32d. A connection opening 12a is provided in a substantially central portion of the connection ring component 12, and a strap pin 15 provided at one end of the body of the electric guitar 200 is fitted in this connection opening 12a, whereby the connection ring component 12 connects the musical sound control apparatus 10 and the electric guitar 200 together.

The case 20, which is the apparatus main body, has a front case 21 constituting a front portion of the case 20 and a back case 22 constituting a back portion of the case 20, and various component elements are accommodated between the front case 21 and the back case 22. In the front case 21, an outer circumference of an edge portion of a front surface 21c is chamfered into a sloping section 21a. A substantially upper half area (a substantially U-shaped area) of the sloping section 21a is formed of a light transmitting material into an indicator section 21b. Additionally, four button openings 21d are provided in an upper portion of the front surface 21c of the front case 21 in order to expose four button sections 42, which will be described later, to an exterior of the case 20.

A substrate 40 is accommodated inside the front case 21. Nine LEDs 41, the four button sections 42, and a control unit (processor) 50 are mounted on the substrate 40. The nine LEDs 41 are provided at equal intervals at portions which correspond to the indicator section 21 of the front case 21, and the four button sections 42 are provided at portions corresponding individually to the button openings 21d in the front case 21. Illumination modes of the individual LEDs 41 are controlled by the control unit 50. Lights emitted from the individual LEDs 41 are transmitted through the indicator section 21b to be visible to the player or the like.

The button sections 42 are configured to receive a press-down operation by the player. One of the four button sections 42 is made into a hold button (a second detector, a switch) 42A. The hold button 42A is a button configured to receive an instruction to switch output modes of a control signal, which will be described later, from the player. In the case that the hold button 42A is pressed down by the player, the hold button 42A detects that the hold button 42A is pressed down (moved) by the player and outputs a detection signal. A function to switch on or off a power supply to the musical sound control apparatus 10, a function to gain access to a Bluetooth (a registered trademark) pairing function, a function to reverse the positive and negative phases of a musical sound, and the like are allocated to the other three button sections 42, these functions being made to be activated by the button sections 42 being pressed down.

A force sensor 30 is accommodated inside the back case 22. Additionally, a battery (not shown) for supplying electric power to the musical sound control apparatus 10 is accommodated on a back surface side of the back case 22. The force sensor 30 is made up of a load cell 38, the first shaft 31, the second shaft 32, and the like. The load cell 38 is made up of a metallic elastic body of a rectangular parallelepiped shape, and a sensor device such as a strain gauge, not shown, or the like is provided at a central portion in a left-right direction of the load cell 38.

The first shaft 31 is a substantially cylindrical shaft component, and an upper end thereof is exposed upwards of the back case 22. Then, the first shaft 31 is connected to the first connection shaft 31d in such a manner as to rotate around the axis of the first connection shaft 31d. A lower end of the first shaft 31 is connected to the load cell 38 via a metallic sheet, not shown, in such a manner as to rotate around an axis of the first shaft 31. The second shaft 32 is a substantially cylindrical shaft component, and a lower end of the second shaft 32 is exposed downwards of the back case 22. Then, the second shaft 32 is connected to the second connection shaft 32d in such a manner as to rotate around the axis of the second connection shaft 32d. An upper end of the second shaft 32 is connected to the load cell 38 via a metallic sheet, not shown, in such a manner as to rotate around an axis of the second shaft 32.

Here, a tension generated between the electric guitar 200 and the guitar strap 210 is applied to both of the first shaft 31 and the second shaft 32 via the connection button component 11 and the connection ring component 12, respectively. Then, the load cell 38 is disposed in such a manner that a longitudinal direction of the load cell 38 follows a direction at right angles to an axis direction of the first shaft 31 and the second shaft 32. As a result, when a tension is applied between the first shaft 31 and the second shaft 32 as a result of the player pushing the guitar strap 210 away from the player, the sensor device provided in the load cell 38 measures an extension amount of the load cell 38, and the extension amount so detected is then processed in a control unit (not shown) accommodated in the load cell 38 to thereby be converted into a tension (a detected value). In this way, the force sensor 30 can detect a tension generated between the electric guitar 200 and the guitar strap 210.

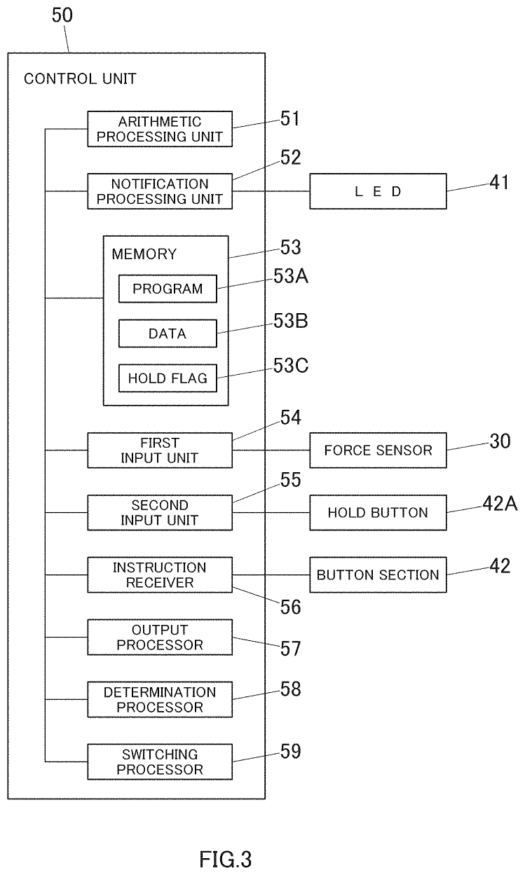

Next, referring to FIG. 3, an electrical configuration of the musical sound control apparatus 10 will be described. The musical sound control apparatus 10 is controlled and supervised wholly by the control unit 50 mounted on the substrate 40. The control unit 50 includes an arithmetic processing unit 51 which is made up of a computer such as a central processing unit (CPU). A notification processing unit (notification processor) 52, a memory 53, a first input unit 54, a second input unit 55, an instruction receiver 56, an output processor 57, a determination processor 58, a switching processor 59, and the like are connected to the arithmetic processing unit 51.

The notification processing unit 52 is configured to notify the player of various pieces of information through the indicator section 21b by controlling the illumination modes of the individual LEDs 41 as a notification device. Specifically speaking, the notification processing unit 52 executes a notification process of notifying the player of a piece of information by changing the colors and intervals of illumination of the LEDs 41 or changing the positions of the nine LEDs 41 for illumination. Here, the notification processing unit 52 may have an incorporated loudspeaker for informing the player of a piece of information.

The memory 53 is made up of an electrically erasable programmable ROM (EEPROM) for storing a program for controlling the CPU, a flash memory for temporarily storing various types of data 53B, and the like. A program (a musical sound control program) 53A for executing a sensor operation, which will be described later, is stored in the memory 53. Additionally, a hold flag 53C is stored in the memory 53 together with its states (an ON state or an OFF state).

The first input unit 54 is configured to capture a detection signal (a detection value) output from the force sensor 30 described above. The second input unit 55 is configured to capture a detection signal output from the hold button 42A when the hold button 42A is pressed down. The instruction receiver 56 is configured to receive various types of instructions from the player when the player presses down the button sections 42 excluding the button 42A.

The output processor 57 outputs a signal configured to control a musical sound according to a detection value of the force sensor 30 (hereinafter, referred to as a “control signal”) to the receiver 80. A control signal is output in either of output modes of a normal output (a first mode) and a hold output (a second mode). When referred to herein, the normal output refers to an output mode for outputting a control signal corresponding to a detection value of the force sensor 30 without holding the output of the control signal which is being output, and the hold output refers to an output mode for holding the output of a control signal which is being output without outputting a control signal corresponding to a detection value of the force sensor 30. The output processor 57 switches the output modes of a control signal according to a state of a hold flag 53C stored in the memory 53. That is, when the hold flag 53C is in an OFF state, the output processor 57 outputs a control signal in the normal output, while when the hold flag 53C is in an ON state, the output processor 57 outputs a control signal in the hold output.

The determination processor 58 monitors the second input unit 55 and determines that a predetermined condition is met when the hold button 42A is pressed down, that is, a detection signal from the hold button 42A is input into the second input unit 55. When the determination processor determines that the predetermined condition is met, the switching processor 59 switches the output modes of the control signal in the output processor 57.

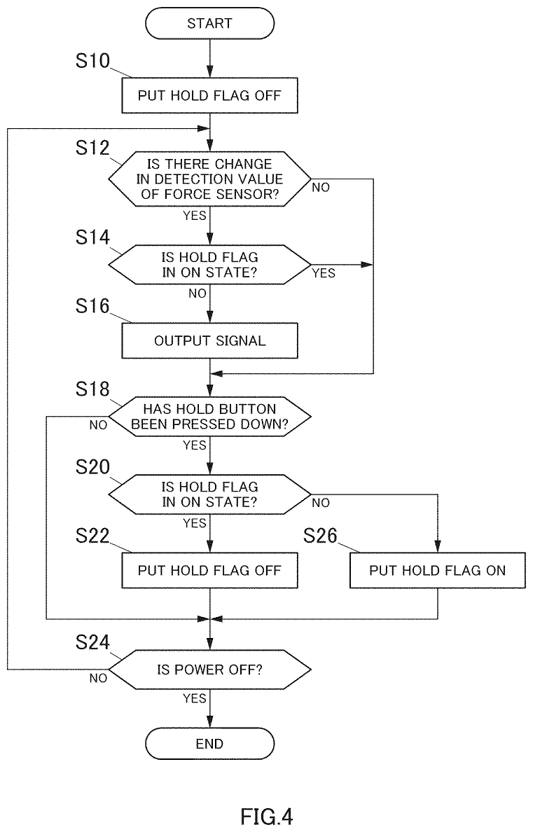

With the musical sound control apparatus 10 according to the first embodiment, a process of holding a control signal being output (hereinafter, referred to as a “hold process”) is executed when the player presses down the hold button 42A. Hereinafter, referring to FIG. 4, a hold process executed by the control unit 50 of the musical sound control apparatus 10 according to the first embodiment will be described. A hold process is started when the power of the musical sound control apparatus 10 is switched on. In the hold process, the control unit 50 firstly puts the hold flag 53C stored in the memory 53 in the OFF state (Step S10).

Subsequently, the control unit 50 determines from a detection value of the force sensor 30 which is input from the force sensor 30 into the first input unit 54 whether there has been a change in the detection value of the force sensor 30 (Step S12). Specifically speaking, the control unit 50 compares the detection value of the force sensor 30 which was input previously and the detection value of the force sensor 30 which has been input currently. If there is a change from the detection value input previously, the control unit 50 determines that there is a change in the detection value (S12: YES), and the control unit 50 proceeds to Step S14. On the other hand, if there is no change from the detection value input previously, the control unit 50 determines that there is no change in the detection value (S12: NO), proceeding to Step S18.

In Step S14, the control unit 50 reads out the hold flag 53C stored in the memory 53 and determines whether the hold flag 53C is in the ON state. If the hold flag 53C is in the ON state (S14: YES), the control unit 50 proceeds to Step S18. If the hold flag 53C is not in the ON state, that is, if the hold flag 53C is in the OFF state (S14: NO), the output processor 57 of the control unit 50 outputs a control signal according to the currently input detection value of the force sensor 30 which is detected in Step S12 (an output process) (Step S16), proceeding to Step S18.

In Step S18, the determination processor 58 of the control unit 50 determines whether the hold button 42A is pressed down. If the determination processor 58 determines that the hold button 42A is pressed down (S18: YES), the determination processor 58 determines that a predetermined condition is met, proceeding to Step S20. If the determination processor 58 determines that the hold button 42A is not pressed down (S18: NO), the determination processor 58 proceeds to Step S24.

In Step S20, the switching processor 59 of the control unit 50 reads out the hold flag 53C stored in the memory 53 and determines whether the hold flag 53C is in the ON state. If the hold flag 53C is in the ON state (S20: YES), the switching processor 59 switches the states of the hold flag 53C to the OFF state and causes the memory 53 to store therein the hold flag 53C in the OFF state (a switching process) (Step S22), proceeding to Step S24. If the hold flag 53C is not in the ON state, that is, if the hold flag 53C is in the OFF state (S20: NO), the switching processor 59 switches the states of the hold flag 53C to the ON state and causes the memory 53 to store therein the hold flag 53C in the ON state (a switching process) (Step S26), proceeding to Step S24.

In Step S24, the control unit 50 determines whether the power of the musical sound control apparatus 10 is switched off. If the control unit 50 determines that the power of the musical sound control apparatus 10 is switched off (S24: YES), the control unit 50 ends the sensor process. If the control unit 50 determines that the power of the musical sound control apparatus 10 is not switched off (S24: NO), the control unit 50 returns to Step S12 and executes the process in Step S12. With the musical sound control apparatus 10 according to the first embodiment, the hold process is executed in the way described heretofore. Here, in the hold process, the notification processing unit 52 of the control unit 50 may be configured such that the notification processing unit 52 causes the LEDs 41 to be illuminated in an arbitrary color (for example, green) while the hold flag 53C stays in the OFF state to notify the player that the output mode is the normal output (a second notification mode), whereas the notification processing unit 52 causes the LEDs 41 to be illuminated in another arbitrary color (for example, red) while the hold flag 53C stays in the ON state to notify the player that the output mode is the hold output (a first notification mode).

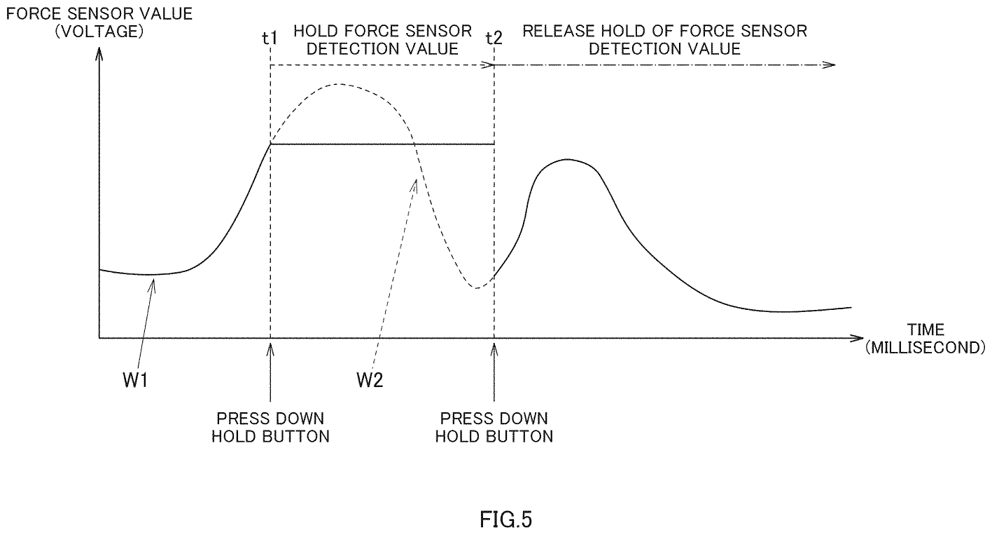

Here, referring to FIG. 5, an example of a waveform showing a change in an output value of a detection value of the force sensor 30 when the output modes of a control signal is switched over alternately between the normal output and the hold output in the hold process will be described. In FIG. 5, an axis of ordinance denotes a detection value (voltage) that is detected by the force sensor 30, and an axis of abscissa denotes time (millisecond). Additionally, in FIG. 5, a waveform W2 indicated by a broken line denotes a detection value of the force sensor 30, and a waveform W1 indicated by a solid line denotes an output value that is output by the output processor 57 in a manner corresponding to a detection value of the force sensor 30.

As shown in FIG. 5, the output mode is the normal output after the initiation of the hold process, and hence, a detection value of the force sensor 30 changes upwards, and an output value that is output from the output processor 57 also changes upwards (refer to a waveform before t1. Here, the waveform W1 and the waveform W2 change equally before t1, and both the waveforms overlap). Then, when the hold button 42A is pressed down at a point in time of the arbitrary time t1, the output modes are switched to the hold output. After the output modes are switched to the hold output, irrespective of a change in a detection value of the force sensor 30 (refer to the waveform W2 between t1 and t2), a control signal corresponding to a detection value of the force sensor 30 at a point in time when the output modes are switched to the hold output (a control signal being output) continues to be output from the output processor 57 while being held thereat without changing (refer to the waveform W1 between t1 and t2).

Then, when the hold button 42A is pressed down again at a point in time of the arbitrary time t2, the output modes are switched to the normal output again. As a result, the hold of the detection value of the force sensor 30 is released, whereafter the output value is output from the output processor 57 while changing according to a change in the detection value of the force sensor 30 (refer to the waveform W1 after t2). In this way, the player can cause the detection value of the force sensor 30 to be held at an arbitrary timing.

Thus, as has been described heretofore, with the musical sound control apparatus 10 according to the first embodiment, as a result of the player pushing the guitar strap 210 away from the player so as to generate a tension between the electric guitar 200 and the guitar strap 210 while the player is playing the electric guitar 200, a control signal configured to control a musical sound is output towards the sound processor 100 according to a detection value that the force sensor 30 detects. Further, when the hold button 42A is pressed down by the player, the output modes of the control signal are switched between the normal output and the hold output. As a result, the player can switch the output modes of the control signal between the normal output and the hold output at an arbitrary timing. In this way, with the musical sound control apparatus 10, an arbitrary modulation amount can be maintained easily without interrupting the play of the electric guitar 200.

In addition, with the musical sound control apparatus 10, the hold button 42A, which constitutes the second detector, is the switch for receiving a switching operation by the player and detects a movement of the switch triggered by the switching operation. Then, in the determination process, the control unit 50 determines that a predetermined condition is met when the switch unit is moved by the switching operation. As a result, a specific configuration can be provided in which the player switches the output modes of the control signal between the normal output and the hold output at an arbitrary timing without interrupting the play of the electric guitar 200.

With the musical sound control apparatus 10, in the switching process, the control unit 50 switches the output modes of the control signal to the hold output on condition that the output mode of the control signal in the output process is the normal output, whereas the control unit 50 switches the output modes of the control signal to the normal output on condition that the output mode of the control signal in the output process is the hold output. As a result, the output modes of the control signal can be switched alternately between the normal output and the hold output by the player intentionally pressing down the hold button 42A.

The musical sound control apparatus 10 includes the LEDs 41 configured to inform the player of the output mode of the control signal in the output process. The control unit 50 has the notification processing unit 52 configured to inform the player of the output mode of the control signal by illuminating the LEDs 41 in red when the output modes of the control signal are switched to the hold output in the switching process and to notify the player of the output mode of the control signal by illuminating the LEDs 41 in green when the output modes of the control signal are switched to the normal output in the switching process. As a result, the player can visually recognize that the current output mode is either of the normal output and the hold output while the player is playing the electric guitar 200.

The musical sound control apparatus 10 can communicate with the receiver 80 that is connected to the sound processor 100 configured to impart effects to a musical sound produced by the electric guitar 200 through radio communication. As a result, a specific configuration can be provided for realizing the play system 1 employing the musical sound control apparatus 10.

The program 53A stored in the memory 53 of the control unit 50 causes the arithmetic processing unit 51 of the control unit 50 which includes the force sensor 30 configured to detect a tension generated between the electric guitar 200 and the guitar strap 210 and the hold button 42A configured to detect a hold button press-down operation in the musical sound control apparatus 10 to execute the determination process of, when a press-down operation is detected by the hold button 42A, determining whether the press-down operation meets the predetermined condition, and the switching process of, when it is determined in the determination process that the press-down operation meets the predetermined condition, switching between the normal output in which a control signal corresponding to a detection value detected by the force sensor 30 is output without holding a control signal being output and the hold output in which the output of the control signal being output is held without outputting the control signal corresponding to the detection value. As a result, it is possible to provide a specific process that the program is caused to execute to realize the configuration in which the control modes of a musical sound can be switched by the player performing the press-down operation on the hold button 42A while controlling the musical sound by, for example, pulling the guitar strap 210 towards the player intentionally.

Here, the musical sound control apparatus of the present disclosure will be described while being compared with the related art. When a musical sound is controlled by employing, for example, the expression pedal, the player can play the musical instrument while holding an arbitrary modulation amount by fixing the pedal in an arbitrary position. With the portable electronic musical instrument described in Japanese Utility Model Publication No. 59-60692 described before, however, when the player plays the musical instrument while holding the arbitrary modulation amount, the player needs to play the musical instrument while continuing to apply a certain pressure to or to generate a certain extension in the strap. As a result, there is a risk of interrupting the play of the musical instrument when attempting to hold the arbitrary modulation amount.

In contrast to this related art, according to the configuration of the present disclosure, it is possible to provide a musical sound control apparatus, a musical sound control method, and a non-transitory computer-readable storage medium storing a program in which an arbitrary modulation amount can easily be maintained without interrupting the play of a musical instrument while realizing a configuration in which a musical sound can be controlled by moving a musical instrument.

### Second Embodiment

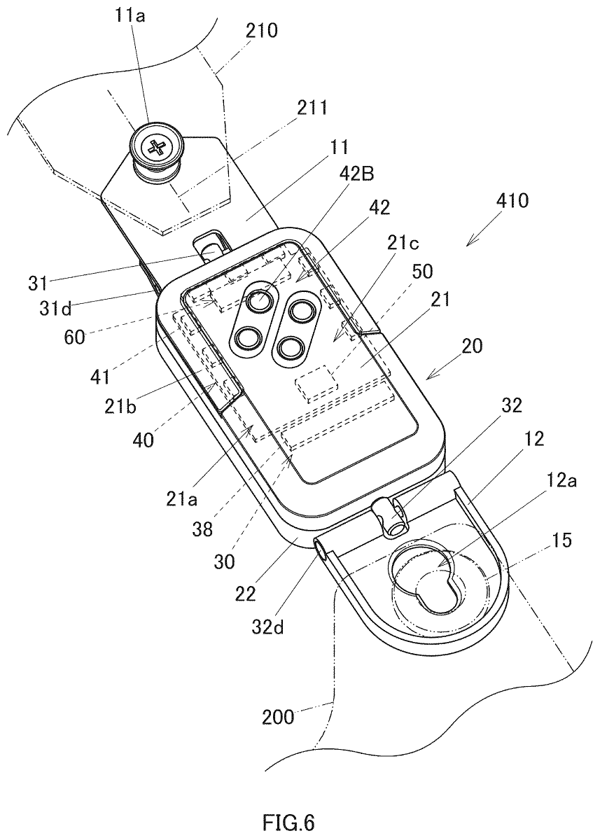

Next, referring to FIGS. 6 to 8, a second embodiment of the present disclosure will be described. Here, in the description of the second embodiment, the description of configurations like to those of the first embodiment will be omitted or simplified. The second embodiment differs from the first embodiment in the configuration of a musical sound control apparatus 410 which includes a gyro-sensor 60, a part of an electrical configuration of the musical sound control apparatus 410, and a predetermined condition on which control signals are switched in a hold process.

As shown in FIG. 6, in the musical sound control apparatus 410 according to the second embodiment, a gyro-sensor (a second detector) 60 is accommodated together with a force sensor 30 inside a back case 22. The gyro-sensor 60 is a small one, and is, for example, a vibration type gyro-sensor. The gyro-sensor 60 detects an angular velocity of a turning movement of the musical sound control apparatus 410 generated when a player who wears the musical sound control apparatus 410 performs a turning movement or when the player rotates the musical sound control apparatus 410 itself. Additionally, four button sections 42 include a memory button 42B among them. The memory button 42B is a button to be pressed down for initiation or termination of a process of causing a memory 53 to store a switching waveform W, which will be described later.

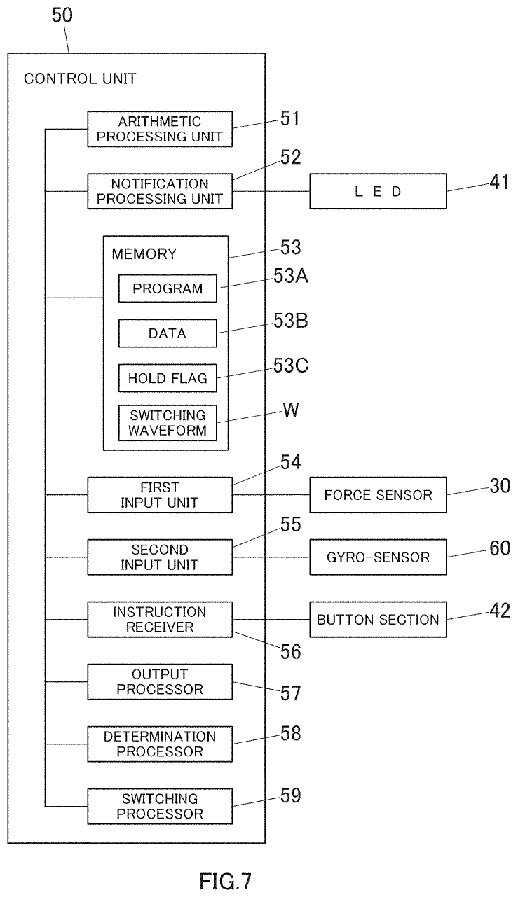

As shown in FIG. 7, a second input unit 55 of a control unit 50 is configured to capture a detection signal (a detection value) output from the gyro-sensor 60. Further, a switching waveform W is stored in a memory 53 of the control unit 50. When referred to herein, the switching waveform W is a waveform to which a switching processor 59 of the control unit 50 refers as a determination factor when the switching processor 59 executes a switching process and is a waveform which is compared with a change in a detection value of the gyro-sensor 60.

The switching waveform W is stored in the memory 53 in advance based on an action of the player. The player turns himself or herself (for example, the player turns once leftwards or counterclockwise), or the player turns the musical sound control apparatus 410 (for example, the player turns the musical sound control apparatus 410 once outwardly), or the player performs a combined action thereof as an action to trigger the execution of a switching process. Then, the memory 53 can be caused to store therein a change in detection values of the gyro-sensor 60 based on these actions of the player as a switching waveform W.

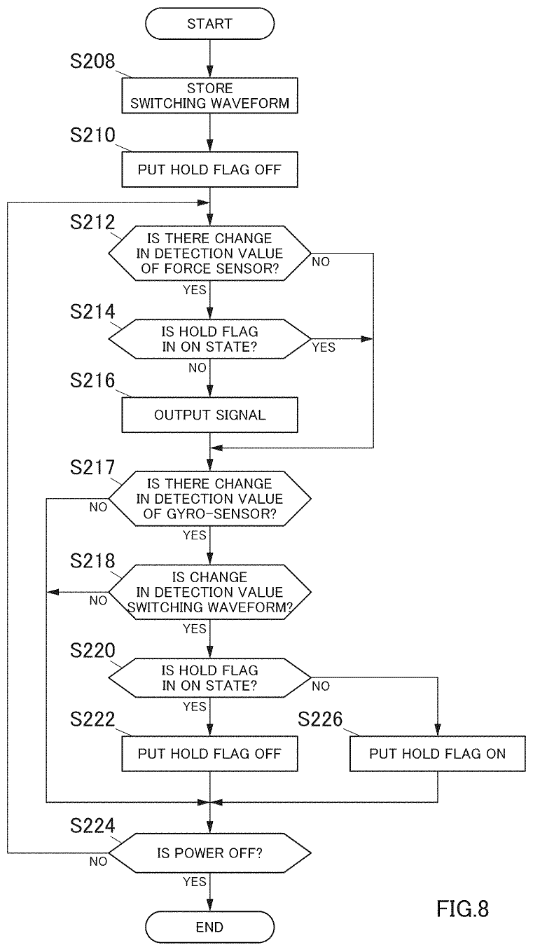

Referring to FIG. 8, a hold process that the musical sound control apparatus 410 according to the second embodiment executes will be described. In the hold process, firstly, a process is executed in which the memory 53 is caused to store therein a switching waveform (Step S208). Specifically speaking, the control unit 50 gives the player an instruction to cause the memory 53 to store therein a switching waveform by changing the illumination modes of the LEDs 41 or emitting a sound from an incorporated loudspeaker. The player responds to the instruction to thereby press down the memory button 42B, whereby the storage of the switching waveform W is initiated.

When the storage of the switching waveform W is initiated, the player performs the action which triggers the switching process, whereby the control unit 50 generates a change in a detection value of the gyro-sensor 60 based on the action of the player as a waveform. Then, the storage of the waveform corresponding to the change in the detection value is terminated by the player pressing down the memory button 42B. The control unit 50 stores waveforms generated from the initiation of the storage of the waveform corresponding to the change in the detection value to the termination of the storage of the same in the memory 53 as a switching waveform W. When the storage of the switching waveform W is terminated, the control unit 50 proceeds to Step S210.

Respective processes in Step S210, Step S212, Step S214, and Step S216 are the same as those in Step S10, Step S12, Step S14, and Step S16 in the first embodiment, and hence, the description of the processing operations in those steps will be omitted here. If NO in Step S212, or if YES in Step S214, or if the processing operation in Step S216 is terminated, the control unit 50 proceeds to Step S217.

In Step S217, a determination processor 58 of the control unit 50 determines from the detection value of the gyro-sensor 60, which is input from the gyro-sensor 60 into a second input unit 55, whether there has been a change in the detection value of the gyro-sensor 60 (a determination process). Specifically speaking, the determination processor 58 determines whether the gyro-sensor 60 detects an angular velocity and whether the angular velocity so detected is not constant and changes. If the gyro-sensor 60 detects the angular velocity and the angular velocity so detected changes, the determination processor 58 determines that there is a change in the detection value (S217: YES), proceeding to Step S218. If the gyro-sensor 60 detects no angular velocity, or if the detected angular velocity is constant, the determination processor 58 determines that there is no change in the detection value (Step S217; NO), proceeding to Step S224.

In Step S218, the determination processor 58 determines whether the change in the detection value of the gyro-sensor 60 matches the switching wave W. Specifically speaking, the determination processor 58 reads out the switching waveform W from the memory 53 and compares the switching waveform W so read out with the waveform corresponding to the change in the detection value of the gyro-sensor 60. If the waveform corresponding to the change in the detection value substantially coincides with the switching waveform W (if the waveform corresponding to the change in the detection value overlaps with the switching waveform W), the determination processor 58 determines that the waveform corresponding to the change in the detection value substantially matches the switching waveform W and that a predetermined condition is met (S218: YES), proceeding to Step S220. If the waveform corresponding to the change in the detection value does not substantially coincide with the switching waveform W, the determination processor 58 determines that the waveform corresponding to the change in the detection value does not match the switching waveform W and that the predetermined condition is not met (S218: NO), proceeding to Step S224.

Respective processes in Step S220, Step S222, Step S224, and Step S226 are the same as those in Step S20, Step S22, Step S24, and Step S26 in the first embodiment, and hence, the description of the process in those steps will be omitted here. With the musical sound control apparatus 410 according to the second embodiment, the hold process is executed in the way described heretofore.

Thus, as has been described heretofore, with the musical sound control apparatus 410 according to the second embodiment, as a result of the player pushing a guitar strap 210 away from the player so as to generate a tension between an electric guitar 200 and the guitar strap 210 while the player is playing the electric guitar 200, a control signal configured to control a musical sound is output towards a sound processor 100 according to a detection value that the force sensor 30 detects. Further, when the player performs the action such as the turning movement predetermined by the player, the detection value detected by the gyro-sensor 60 changes, and if the change in the detection value matches the switching waveform W, the output modes of the control signal are switched between a normal output and a hold output. As a result, the player can switch the output modes of the control signal between the normal output and the hold output at an arbitrary timing. In this way, with the musical sound control apparatus 410, an arbitrary modulation amount can be maintained easily without interrupting the play of the electric guitar 200.

In addition, with the musical sound control apparatus 410, the gyro-sensor 60, which constitutes a second detector, is the sensor for detecting an angular velocity of a movement generated by the turning movement of the musical sound control unit 410. Then, in the determination process, the determination processor 58 determines that the predetermined condition is met if the change in the angular velocity detected by the gyro-sensor 60 is the predetermined change. As a result, a specific configuration can be provided in which the player switches the output modes of the control signal between the normal output and the hold output at an arbitrary timing without interrupting the play of the electric guitar 200.

Thus, the embodiments of the present disclosure have been described heretofore, however, these embodiments are presented as examples, and hence, there is no intention to limit the technical scope of the present disclosure by those embodiments. These novel embodiments can be carried out in other various forms, and various omissions, replacements, and modifications can be made thereto without departing from the spirit and scope of the present disclosure. Those resulting embodiments and modified examples thereof are included in the scope and gist of the present disclosure and are also included in the scope of inventions claimed for patent under claims below and their equivalents.

For example, in the first embodiment, the musical sound control apparatus may have another switching device such as a slide switch in place of the hold button. In addition, in the second embodiment, the musical sound control apparatus may have an acceleration sensor in place of the gyro-sensor. In this case, when the player moves the musical sound control apparatus in an accelerating fashion, the acceleration sensor detects an acceleration of an accelerating movement generated in the musical sound control apparatus. Additionally, in this case, the player causes the memory to store therein a change in a detection value of the acceleration sensor as a switching waveform. Then, the switching processor of the control unit executes a switching process if the waveform corresponding to the change in the detection value of the acceleration sensor substantially coincides with the switching waveform stored in the memory.

What is claimed is:

1. A musical sound control apparatus comprising:
a first detector configured to detect a tension generated between a musical instrument and a musical instrument holder;
an output device configured to output a signal corresponding to a detection value detected by the first detector;
a second detector configured to detect a specific movement of at least a part of the musical sound control apparatus; and
a processor,
wherein the processor executes:
a determination to determine whether the specific movement meets a predetermined condition when the specific movement is detected by the second detector; and
a switching process configured to switch between a first mode and a second mode if it is determined in the determination process that the specific movement meets the predetermined condition,
wherein the first mode changes the signal output by the output device according to a change in the detection value detected by the first detector, and the second mode holds the signal that was output by the output device when the specific movement was detected, without changing the signal output by the output device even if the detection value changes.

2. The musical sound control apparatus according to claim 1,
wherein the second detector is a switch configured to receive a switching operation by a user and is configured to detect the specific movement of the switch by the switching operation, and
wherein the processor determines in the determination process that the predetermined condition is met when the switch is moved by the switching operation.

3. The musical sound control apparatus according to claim 1,
wherein the second detector is a sensor configured to detect an angular velocity of a turning movement of the musical sound control apparatus or an acceleration of a movement by an accelerating movement of the musical sound control apparatus, and
wherein the processor determines in the determination process that the predetermined condition is met when a change in the angular velocity or a change in the acceleration detected in the second detector is a predetermined change.

4. The musical sound control apparatus according to claim 1,
wherein in the switching process, the processor switches output modes of the signal to the second mode on condition that an output mode of the signal output by the output device is in the first mode and switches the output modes of the signal to the first mode on condition that an output mode of the signal output by the output device is in the second mode.

5. The musical sound control apparatus according to claim 1, further comprising:
a notification device configured to notify a user of the output mode of the output device,
wherein the processor has a notification processor that executes a notification by the notification device in a first notification mode when the output mode is switched to the second mode in the switching process, and executes a notification by the notification device in a second notification mode when the output mode is switched to the first mode in the switching process.

6. The musical sound control apparatus according to claim 1, which is capable of wireless communication with a receiver connected to an effect device that imparts effects to a musical sound of the musical instrument.

7. A musical sound control method for a musical sound control apparatus comprising a first detector configured to detect a tension generated between a musical instrument and a musical instrument holder, an output device configured to output a signal corresponding to a detection value detected by the first detector, a second detector configured to detect a specific movement of at least a part of the musical sound control apparatus, and a processor,
wherein the processor executes:
a determination process configured to determine whether the specific movement meets a predetermined condition when the specific movement is detected by the second detector; and
a switching process configured to switch between a first mode and a second mode if it is determined in the determination process that the specific movement meets the predetermined condition, wherein the first mode changes the signal output by the output device according to a change in the detection value detected by the first detector, and the second mode holds the signal that was output by output device when the specific movement was detected, without changing the signal output by the output device even if the detection value changes.

8. The musical sound control method according to claim 7,
wherein the second detector is a switch configured to receive a switching operation by a user and is configured to detect the specific movement of the switch by the switching operation, and
wherein determination process determines that the predetermined condition is met when the switch is moved by the switching operation.

9. The musical sound control method according to claim 7,
wherein the second detector is a sensor configured to detect an angular velocity of a turning movement of the musical sound control apparatus or an acceleration of a movement by an accelerating movement of the musical sound control apparatus, and
wherein the determination process determines that the predetermined condition is met when a change in the angular velocity or a change in the acceleration detected in the second detector is a predetermined change.

10. The musical sound control method according to claim 7,
wherein the switching process switches output modes of the signal to the second mode on condition that an output mode of the signal output by the output device is in the first mode and switches the output modes of the signal to the first mode on condition that an output mode of the signal output by the output device is in the second mode.

11. The musical sound control method according to claim 7, further comprising:
a notification device configured to notify a user of the output mode of the output device,
wherein a notification by the notification device in a first notification mode is executed when the output mode is switched to the second mode in the switching process, and a notification by the notification device in a second notification mode is executed when the output mode is switched to the first mode in the switching process.

12. A non-transitory computer-readable storage medium storing a program, wherein the program causes a computer of a musical sound control apparatus which comprises a first detector configured to detect a tension generated between a musical instrument and a musical instrument holder, an output device configured to output a signal corresponding to a detection value detected by the first detector, and a second detector configured to detect a specific movement of at least a part of the musical sound control apparatus, to execute:
determining whether the specific movement meets a predetermined condition when the specific movement is detected by the second detector; and
switching between a first mode and a second mode if it is determined in the determining that the specific movement meets the predetermined condition,
wherein the first mode changes the signal output by the output device according to a change in the detection value detected by the first detector, and the second mode holds the signal that was output by output device when the specific movement was detected, without changing the signal output by the output device even if the detection value changes.

13. The non-transitory computer-readable storage medium storing a program according to claim 12,
wherein the second detector is a switch configured to receive a switching operation by a user and is configured to detect the specific movement of the switch by the switching operation, and
wherein the determining determines that the predetermined condition is met when the switch is moved by the switching operation.

14. The non-transitory computer-readable storage medium storing a program according to claim 12,
wherein the second detector is a sensor configured to detect an angular velocity of a turning movement of the musical sound control apparatus or an acceleration of a movement by an accelerating movement of the musical sound control apparatus, and
wherein the determining determines that the predetermined condition is met when a change in the angular velocity or a change in the acceleration detected in the second detector is a predetermined change.

15. The non-transitory computer-readable storage medium storing a program according to claim 12,
wherein output modes of the signal are switched to the second mode on condition that an output mode of the signal output by the output device is in the first mode and the output modes of the signal is switched to the first mode on condition that an output mode of the signal output by the output device is in the second mode.

16. The non-transitory computer-readable storage medium storing a program according to claim 12, further comprising:
a notification device configured to notify a user of the output mode of the output device,
wherein notification by the notification device in a first notification mode is performed when the output mode is switched to the second mode, and notification by the notification device in a second notification mode is performed when the output mode is switched to the first mode.
